(19) United States
(12) Patent Application Publication
(10) Pub. No.: US 2024/0118927 A1
(43) Pub. Date: Apr. 11, 2024

(54) Memory Pooling Method and Related Apparatus

(71) Applicant: Huawei Technologies Co., Ltd., Shenzhen (CN)

(72) Inventors: Hongwei Sun, Beijing (CN); Guangcheng Li, Beijing (CN); Xiuqiao Li, Beijing (CN); Xiaoming Bao, Beijing (CN); Jun You, Chengdu (CN)

(21) Appl. No.: 18/536,885

(22) Filed: Dec. 12, 2023

Related U.S. Application Data
(63) Continuation of application No. PCT/CN2022/093194, filed on May 17, 2022.

(30) Foreign Application Priority Data
Jun. 15, 2021 (CN) 202110661538.7
Aug. 30, 2021 (CN) 202111007559.3

(51) Int. Cl. G06F 9/50

(52) U.S. Cl. CPC G06F 9/5016; G06F 9/5072; G06F 2209/5011

(57) ABSTRACT

A server cluster determines a first memory requirement of a first distributed application, where the first memory requirement indicates a memory size. The server cluster determines N first server nodes in the server cluster based on the first memory requirement and an available memory resource of each server node in the server cluster, and constructs a first memory pool based on the N first server nodes. The server cluster provides a service for the first distributed application based on the first memory pool.

### CROSS-REFERENCE TO RELATED APPLICATIONS

This is a continuation of International Patent Application No. PCT/CN2022/093194 filed on May 17, 2022, which claims priority to Chinese Patent Application No. 202111007559.3 filed on Aug. 30, 2021 and Chinese Patent Application No. 202110661538.7 filed on Jun. 15, 2021, which are hereby incorporated by reference in their entireties.

### TECHNICAL FIELD

Embodiments of this disclosure relate to the field of computers, and in particular, to a memory pooling method and a related apparatus.

### BACKGROUND

A server cluster is a group of servers connected together to jointly implement a task. A distributed application may be deployed on a plurality of servers in the server cluster, to support running of the distributed application.

However, performance of the distributed application is still not satisfactory and needs to be further improved.

### SUMMARY

Embodiments of this disclosure provide a memory pooling method and a related apparatus.

A first aspect of embodiments of this disclosure provides a memory pooling method.

When a first distributed application needs to be run in a server cluster, a first memory requirement of the first distributed application is determined, where the first memory requirement indicates a memory size. Each server node in the server cluster has an available memory resource, and after the first memory requirement is determined, N first server nodes in the server cluster are determined based on the first memory requirement and the available memory resource of each server node in the server cluster, where N is an integer greater than or equal to 2. After the N first server nodes are determined, a first memory pool is constructed based on the N first server nodes. Then the server cluster provides a service for the first distributed application based on the first memory pool.

In embodiments of this disclosure, a service is provided for an application by constructing a memory pool in a server cluster. Because data may be transmitted in the memory pool through remote direct memory access, workload of a central processing unit (CPU) of a server node is reduced. Therefore, performance of a distributed application can be improved. In addition, as a quantity of running distributed applications increases, a size of the memory pool in the server cluster also increases.

In a possible implementation, a type of the first distributed application may further be determined. Then, the N first server nodes in the server cluster are determined based on the type of the first distributed application, the first memory requirement, and the available memory resource of each server node.

In a possible implementation, a memory ballooning coefficient corresponding to the type of the first distributed application is determined based on the type of the first distributed application. Then, the N first server nodes in the server cluster are determined based on the memory ballooning coefficient, the first memory requirement, and the available memory resource of each server node.

In embodiments of this disclosure, the N first server nodes may be further determined based on the type of the distributed application, to improve accuracy of selecting a quantity of server nodes.

In a possible implementation, when a second distributed application further needs to be run in the server cluster, a second memory requirement of the second distributed application and a type of the second distributed application may be determined. If a difference between the second memory requirement and the first memory requirement is less than a preset value and the type of the first distributed application is the same as the type of the second distributed application, services are provided for the first distributed application and the second distributed application respectively in different time periods based on the first memory pool.

In embodiments of this disclosure, when the memory requirements of the two distributed applications are less than the preset value and the types of the two distributed applications are the same, one memory pool may be directly reused, and no new memory pool needs to be constructed.

A second aspect of embodiments of this disclosure provides a server cluster. The server cluster includes corresponding functional units configured to implement the method in the first aspect.

A third aspect of embodiments of this disclosure provides a server cluster. The server cluster includes a processor. The processor is coupled to a memory. The memory is configured to store instructions. When the instructions are executed by the processor, the server cluster is enabled to perform the method in the first aspect.

A fourth aspect of embodiments of this disclosure provides a computer-readable storage medium. The computer-readable storage medium is configured to store instructions. The instructions are used to perform the method in the first aspect.

### BRIEF DESCRIPTION OF DRAWINGS

FIG. 1 is a schematic diagram of an application scenario of a memory pooling method according to an embodiment of this disclosure;

FIG. 2A is a schematic flowchart of a memory pooling method according to an embodiment of this disclosure;

FIG. 2B is a schematic diagram of constructing a memory pool according to an embodiment of this disclosure;

FIG. 3 is a schematic diagram of constructing a memory pool according to an embodiment of this disclosure;

FIG. 4 is another schematic flowchart of a memory pooling method according to an embodiment of this disclosure;

FIG. 5 is another schematic flowchart of a memory pooling method according to an embodiment of this disclosure;

FIG. 6 is a schematic structural diagram of a server cluster according to an embodiment of this disclosure; and

FIG. 7 is another schematic structural diagram of a server cluster according to an embodiment of this disclosure.

### DESCRIPTION OF EMBODIMENTS

In the specification, claims, and accompanying drawings of this disclosure, the terms “first”, “second”, and the like are intended to distinguish between similar objects but do not necessarily indicate a particular order or sequence. It should be understood that data termed in such a way are interchangeable in proper cases so that embodiments described herein can be implemented in other orders than the order illustrated or described herein. In addition, the terms “include” and “have” and any other variants thereof are intended to cover a non-exclusive inclusion. For example, a process, method, system, product, or device that includes a list of steps or units is not limited to those expressly listed steps or units, but may include other steps or units not expressly listed or inherent to such a process, method, product, or device.

Embodiments of this disclosure provide a memory pooling method, to improve performance of a distributed application.

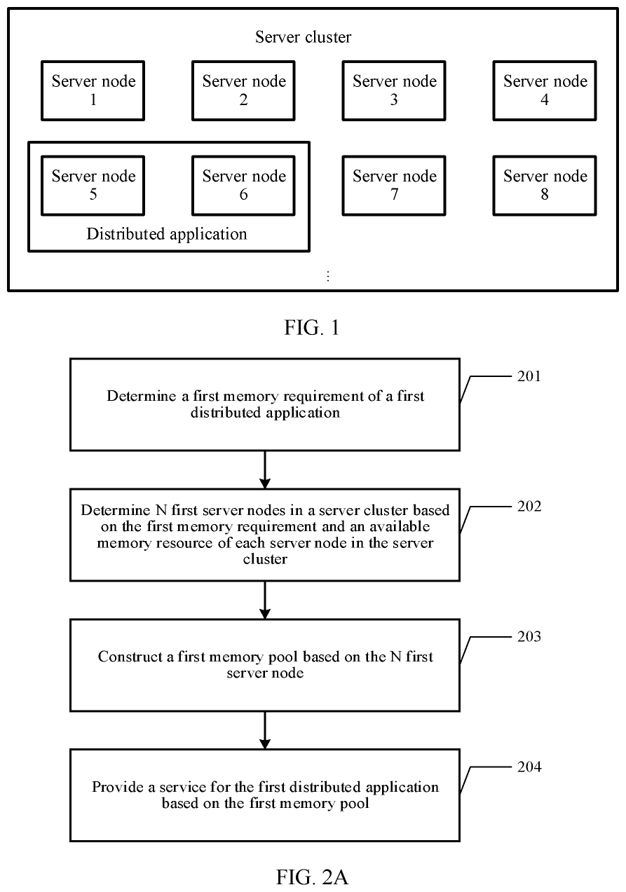

Embodiments of this disclosure may be applied to a server cluster shown in FIG. 1. As shown in FIG. 1, the server cluster includes a plurality of server nodes interconnected by a network, and the server nodes closely cooperate with each other to implement a task. For a user, the server cluster as a whole may be considered as a server. A distributed application is an application that runs based on different server nodes in the server cluster. For example, a distributed application is deployed on a server node 5 and a server node 6, and the server node 5 and the server node 6 jointly support running of the distributed application. However, in conventional technologies, because data transmission between server nodes needs to consume a large quantity of processing capabilities of a central processing unit, performance of the distributed application is limited to some extent. Consequently, the performance of the distributed application cannot meet a requirement.

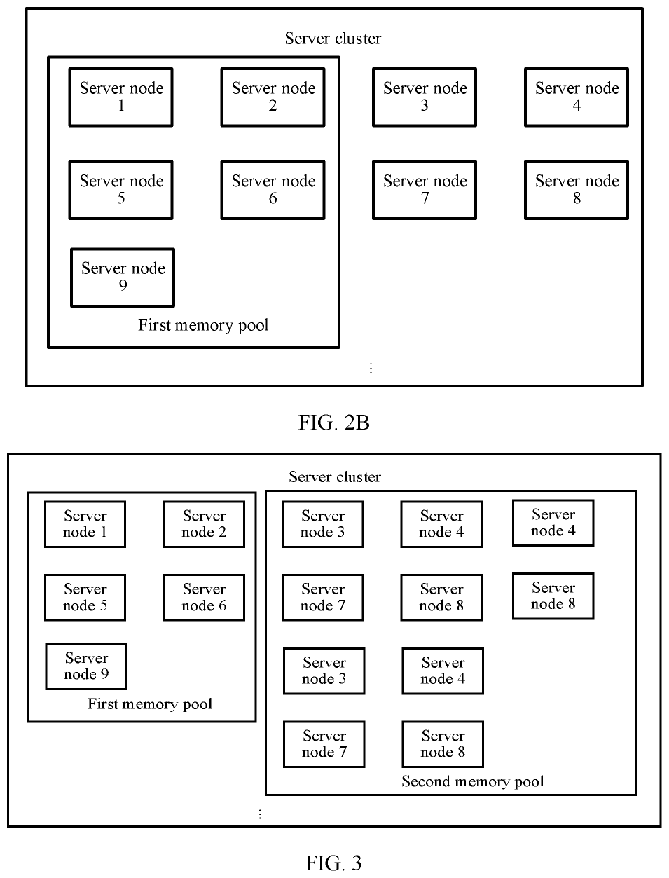

Refer to FIG. 2A. A memory pooling method in an embodiment of this disclosure is described below.

201: Determine a first memory requirement of a first distributed application.

When a user needs to run the first distributed application in a server cluster, the server cluster first needs to determine the first memory requirement required for running the first distributed application. Different applications usually have different memory requirements. For example, an application 1 requires a memory resource of 1 terabyte (T), an application 2 requires a memory resource of 4 T, and an application 3 requires a memory resource of 5 T. In this embodiment, an example in which the first distributed application requires a memory resource of 1 T is used for description.

202: Determine N first server nodes in the server cluster based on the first memory requirement and an available memory resource of each server node in the server cluster.

Each server node in the server cluster has an available memory resource. After determining the first memory requirement of the first distributed application, the server cluster determines the N first server nodes in the server cluster based on the available memory resource of each server node in the server cluster and the first memory requirement. A sum of the available memory resources of the N first server nodes meets the first memory requirement.

In a preferred manner, the server nodes in the server cluster have approximately the same available memory resource. For example, the available memory resource of each server node is 0.2 T. In this case, a required quantity N of server nodes may be determined based on the first memory requirement D and the available memory resource M of each server node, where N satisfies Formula (1):

$$N = \frac{D}{M} \qquad ( 1 )$$

The foregoing data is used as an example. When D is 1 T and M is 0.2 T, N is 5. To be specific, five server nodes need to be selected from the server cluster to provide a service for the first distributed application, and these server nodes are the first server nodes.

It should be noted that in an actual implementation, if N obtained through calculation based on Formula (1) is not an integer, a ceiling method may be used. For example, when an obtained result of N is 5.3, N takes a value of 6.

203: Construct a first memory pool based on the N first server nodes.

For example, refer to FIG. 2B. After five first server nodes are determined, the first memory pool is constructed based on the five first server nodes.

204: Provide a service for the first distributed application based on the first memory pool.

After the first memory pool is constructed, the service is provided for the first distributed application based on the first memory pool.

Certainly, in addition to the first distributed application, another distributed application also needs to run in the server cluster, and a memory pool may be constructed for the other distributed application based on the foregoing method. For example, a memory requirement of a distributed application A is 2 T. Refer to FIG. 3. According to the foregoing method, it may be determined that 10 second server nodes need to be selected from the server cluster to construct a second memory pool, and a service is provided for the distributed application A based on the second memory pool.

It may be understood that in an actual implementation, a process of determining the N server nodes based on the memory requirement of the application and the available memory resource of each server node may be performed in advance, in other words, a mapping relationship between the memory requirement of the application and a quantity of server nodes required for constructing the memory pool may be determined in advance. For example, when the memory requirement of the application is 4 T, it is determined that a memory pool constructed by 20 server nodes is required to provide a service for the application. When the memory requirement of the application is 5 T, it is determined that a memory pool constructed by 25 server nodes is required to provide a service for the application. After such a mapping relationship is determined, when an application having a memory requirement of 5 T or 4 T needs to be run, a quantity of server nodes required for constructing a memory pool that provides a service for the application may be directly determined based on the mapping relationship.

In embodiments of this disclosure, a service is provided for an application by constructing a memory pool in a server cluster. Because data may be transmitted in the memory pool through remote direct memory access, workload of a central processing unit of a server node is reduced. Therefore, performance of a distributed application can be improved. In addition, as a quantity of running distributed applications increases, a size of the memory pool in the server cluster also increases.

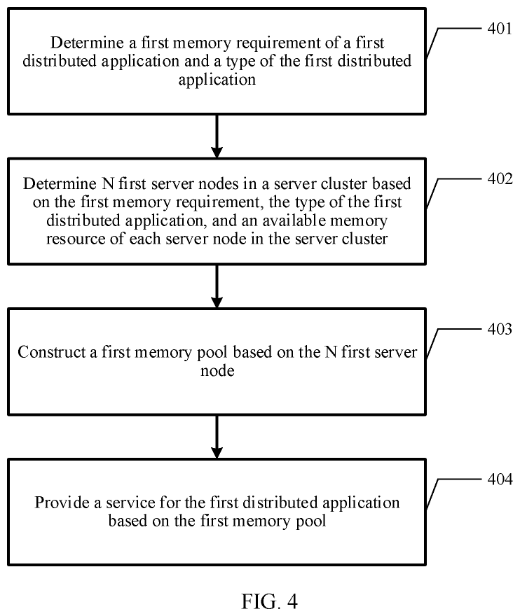

Based on the embodiment shown in FIG. 2A, a quantity of server nodes required for constructing a memory pool that provides a service for an application may be further determined based on a type of the application. Refer to FIG. 4. A detailed description is given below.

401: Determine a first memory requirement of a first distributed application and a type of the first distributed application.

Based on characteristics of distributed applications, distributed applications may be classified into different types, for example, a database application and a big data application. Due to impact of the characteristics of the distributed applications, a server cluster also needs to consider the type of the first distributed application when determining a quantity of server nodes required for creating a first memory pool that provides a service for the first distributed application. For example, in this embodiment, the type of the first distributed application is a database application, and a memory requirement of the first distributed application is 1 T.

402: Determine N first server nodes in the server cluster based on the first memory requirement, the type of the first distributed application, and an available memory resource of each server node in the server cluster.

In this embodiment, different application types correspond to different memory ballooning coefficients. For example, a database application corresponds to a memory ballooning coefficient of 1, and a big data application corresponds to a memory ballooning coefficient of 2. First, a corresponding ballooning coefficient is determined based on the type of the first distributed application. Then the N first server nodes in the server cluster are determined based on the ballooning coefficient, the first memory requirement of the first distributed application, and the available memory resource of each server node in the server cluster.

For example, when the first distributed application is a database application, the corresponding memory ballooning coefficient P is 1.2. In this case, a quantity N of server nodes is required, where N satisfies Formula (2):

$$N = \frac{D \times P}{M} \qquad ( 2 )$$

For example, if M is 0.2, D is IT, and P is 1.2, N is 6.

Steps 403 to 404 in this embodiment are similar to steps 203 to 204 in the embodiment shown in FIG. 2A. Details are not described herein again. To be specific, six server nodes need to be selected from the server cluster to provide a service for the first distributed application, and these server nodes are the first server nodes.

Certainly, in addition to determining the memory ballooning coefficient based on the type of the distributed application, an algorithm for calculating a quantity of server nodes required for constructing a memory pool may be correspondingly improved based on the type of the distributed application. A specific improvement manner is not limited herein.

In embodiments of this disclosure, the N first server nodes may be further determined based on the type of the distributed application, to improve accuracy of selecting a quantity of server nodes.

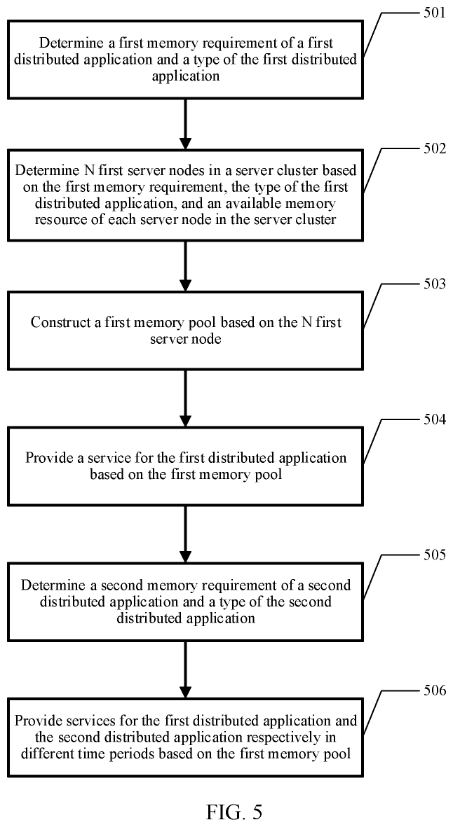

Alternatively, in an actual implementation, when a distributed application to be run later has a similar memory resource requirement to that of the distributed application that is currently being run and the two distributed applications are of the same type, one memory pool may be reused for the two distributed applications. Refer to FIG. 5. A detailed description is given below.

Steps 501 to 504 in this embodiment are similar to steps 401 to 404 in the embodiment shown in FIG. 4. Details are not described herein again.

505: Determine a second memory requirement of a second distributed application and a type of the second distributed application.

If the second distributed application further needs to be run in the server cluster, the second memory requirement of the second distributed application and the type of the second distributed application are determined. For example, the second memory requirement is 1.02 T, and the type of the second distributed application is a database application.

506: Provide services for the first distributed application and the second distributed application respectively in different time periods based on the first memory pool.

The first memory requirement of the first distributed application is 1 T, and the second memory requirement of the second distributed application is 1.02 T. In an actual implementation, a preset value may be set. When a difference between the memory requirements of the two distributed applications is less than the preset value, it indicates that the memory requirements of the two distributed applications are close. For example, when the preset value is 0.01 T, it indicates that the memory requirements of the first distributed application and the second distributed application are close.

Provided that the memory requirements of the two distributed applications are close, if the two distributed applications are also of the same type, for example, if both the first distributed application and the second distributed application are database applications, one memory pool may be reused for the two distributed applications. Further, the first memory pool may be used to provide services for the first distributed application and the second distributed application respectively in different time periods. For example, the first memory pool is used to provide the service for the first distributed application in a time period 1, and the first memory pool is used to provide the service for the second distributed application in a time period 2. Therefore, no new memory pool needs to be constructed for the second distributed application.

Certainly, if the difference between the second memory requirement of the second distributed application and the first memory requirement is greater than the preset value or the type of the second distributed application is different from that of the first distributed application, a new memory pool is constructed for the second distributed application. A specific construction process is similar to the process of constructing the memory pool for the first distributed application, and details are not described herein again.

In embodiments of this disclosure, when the memory requirements of the two distributed applications are less than the preset value and the types of the two distributed applications are the same, one memory pool may be directly reused, and no new memory pool needs to be constructed.

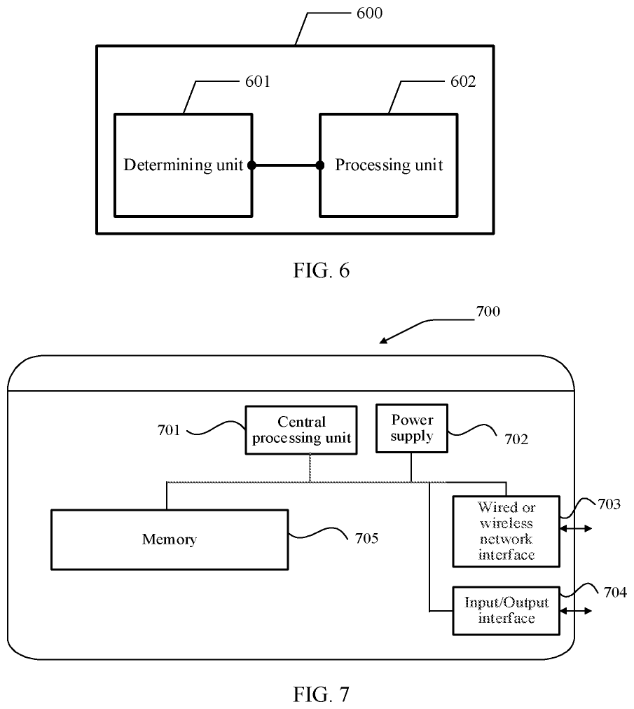

The foregoing describes the memory pooling method in embodiments of this disclosure. Refer to FIG. 6. The following describes a server cluster in embodiments of this disclosure.

As shown in FIG. 6, a server cluster 600 in an embodiment of this disclosure includes a determining unit 601 and a processing unit 602.

The determining unit 601 is configured to determine a first memory requirement of a first distributed application, where the first memory requirement indicates a memory size.

The determining unit 601 is further configured to determine N server nodes in the server cluster based on the first memory requirement and an available memory resource of each server node in the server cluster, where N is an integer greater than or equal to 2.

The processing unit 602 is configured to construct a first memory pool based on the N first server nodes.

The processing unit 602 is further configured to provide a service for the first distributed application based on the first memory pool.

In a possible implementation, the determining unit 601 is further configured to determine a type of the first distributed application.

The determining unit 601 is further configured to determine the N first server nodes in the server cluster based on the first memory requirement, the type of the first distributed application, and the available memory resource of each node in the server cluster.

In a possible implementation, the determining unit 601 is further configured to determine, based on the type of the first distributed application, a memory ballooning coefficient corresponding to the first distributed application.

The determining unit 601 is further configured to determine the N first server nodes in the server cluster based on the first memory requirement, the memory ballooning coefficient corresponding to the first distributed application, and the available memory resource of each server node in the server cluster.

In a possible implementation, the determining unit 601 is further configured to determine a second memory requirement of a second distributed application and a type of the second distributed application.

The processing unit 602 is further configured to provide services for the second distributed application and the first distributed application respectively in different time periods based on the first memory pool when a difference between the second memory requirement and the first memory requirement is less than a preset value and the type of the first distributed application is the same as the type of the second distributed application.

FIG. 7 is a schematic structural diagram of a server cluster according to an embodiment of this disclosure. The server cluster 700 may include one or more CPUs 701 and a memory 705. The memory 705 stores one or more applications or data.

The memory 705 may be a volatile storage or a persistent storage. The application stored in the memory 705 may include one or more modules, and each module may include a series of instruction operations for a server. Further, the central processing unit 701 may be configured to communicate with the memory 705, and execute, on a server node, the series of instruction operations in the memory 705.

The server cluster 700 may further include one or more power supplies 702, one or more wired or wireless network interfaces 703, one or more input/output interfaces 704, and/or one or more operating systems, such as Windows Server™, Mac OS X™, Unix™, Linux™, and FreeBSD™.

The central processing unit 701 may perform the methods in the embodiments shown in FIG. 2A, FIG. 4, and FIG. 5, and details are not described herein again.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this disclosure may be integrated into one processing unit, each of the units may exist alone physically, or two or more units are integrated into one unit. The integrated unit may be implemented in a form of hardware, or may be implemented in a form of a software functional unit.

When the integrated unit is implemented in a form of a software functional unit and sold or used as an independent product, the integrated unit may be stored in a computer-readable storage medium. Based on such an understanding, the technical solutions of this disclosure essentially, or the part contributing to conventional technologies, or all or some of the technical solutions may be implemented in a form of a software product. The computer software product is stored in a storage medium and includes several instructions for instructing a computer device (which may be a personal computer, a server, a network device, or the like) to perform all or some of the steps of the methods described in embodiments of this disclosure. The storage medium includes any medium that can store program code, such as a Universal Serial Bus (USB) flash drive, a removable hard disk, a read-only memory (ROM), a random-access memory (RAM), a magnetic disk, or an optical disc.

1. A method comprising:
determining a first memory requirement of a first distributed application, wherein the first memory requirement indicates a memory size;
determining N first server nodes from among second server nodes in a server cluster based on the first memory requirement and available memory resources of the second server nodes, wherein N is an integer greater than or equal to 2;
constructing a memory pool based on the N first server nodes; and
providing a first service for the first distributed application based on the memory pool.

2. The method of claim 1, wherein determining the N first server nodes comprises:
determining a first type of the first distributed application; and
further determining the N first server nodes based on the first type.

3. The method of claim 2, wherein determining the N first server nodes further comprises:
determining a memory ballooning coefficient corresponding to the first distributed application based on the first type; and
further determining the N first server nodes based on the memory ballooning coefficient.

4. The method of claim 3, further comprising:
determining a second memory requirement of a second distributed application and a second type of the second distributed application;
identifying that a difference between the second memory requirement and the first memory requirement is less than a preset value and the first type is the same as the second type; and
providing second services for the second distributed application and the first distributed application respectively in different time periods based on the memory pool in response to identifying that the difference is less than the preset value and the first type is the same as the second type.

5. A server cluster comprising:
a memory configured to store instructions; and
one or more processors coupled to the memory and configured to execute the instructions to cause the server cluster to:
determine a first memory requirement of a first distributed application, wherein the first memory requirement indicates a memory size;
determine N first server nodes from among second server nodes in the server cluster based on the first memory requirement and available memory resources of the second server nodes, wherein N is an integer greater than or equal to 2;
construct a memory pool based on the N first server nodes; and
provide a first service for the first distributed application based on the memory pool.

6. The server cluster of claim 5, wherein the one or more processors are further configured to execute the instructions to cause the server cluster to:
determine a first type of the first distributed application; and
further determine the N first server nodes based on the first type.

7. The server cluster of claim 6, wherein the one or more processors are further configured to execute the instructions to cause the server cluster to:
determine a memory ballooning coefficient corresponding to the first distributed application based on the first type; and
further determine the N first server nodes based on the memory ballooning coefficient.

8. The server cluster of claim 7, wherein the one or more processors are further configured to execute the instructions to cause the server cluster to:
determine a second memory requirement of a second distributed application and a second type of the second distributed application;
identify that a difference between the second memory requirement and the first memory requirement is less than a preset value and the first type is the same as the second type; and
provide second services for the second distributed application and the first distributed application respectively in different time periods based on the memory pool in response to identifying that the difference is less than the preset value and the first type is the same as the second type.

9. A computer program product comprising computer-executable instructions that are stored on a non-transitory computer-readable storage medium and that, when executed by one or more processors, cause a server cluster to:
determine a first memory requirement of a first distributed application, wherein the first memory requirement indicates a memory size;
determine N first server nodes from among second server nodes in the server cluster based on the first memory requirement and available memory resources of the second server nodes, wherein N is an integer greater than or equal to 2;
construct a memory pool based on the N first server nodes; and
provide a first service for the first distributed application based on the memory pool.

10. The computer program product of claim 9, wherein the computer-executable instructions further cause the server cluster to:
determine a first type of the first distributed application; and
further determine the N first server nodes based on the first type.

11. The computer program product of claim 10, wherein the computer-executable instructions further cause the server cluster to:
determine a memory ballooning coefficient corresponding to the first distributed application based on the first type; and
further determine the N first server nodes based on the memory ballooning coefficient.

12. The computer program product of claim 11, wherein the computer-executable instructions further cause the server cluster to:
determine a second memory requirement of a second distributed application and a second type of the second distributed application;
identify that a difference between the second memory requirement and the first memory requirement is less than a preset value and the first type is the same as the second type; and
provide second services for the second distributed application and the first distributed application respectively in different time periods based on the memory pool in response to identifying that the difference is less than the preset value and the first type is the same as the second type.

13. The computer program product of claim 9, wherein a sum of the available memory resources of the N first server nodes meets the first memory requirement.

14. The computer program product of claim 9, wherein the computer-executable instructions further cause the server cluster to obtain a mapping relationship between the first memory requirement and a quantity of first server nodes required for constructing the memory pool before determining the N first server nodes.

15. The computer program product of claim 10, wherein the first type is a database application type.

16. The computer program product of claim 10, wherein the first type is a big data application type.

17. The method of claim 1, wherein a sum of the available memory resources of the N first server nodes meets the first memory requirement.

18. The method of claim 1, further comprising obtaining a mapping relationship between the first memory requirement and a quantity of first server nodes required for constructing the memory pool before determining the N first server nodes.

19. The method of claim 2, wherein the first type is a database application type.

20. The method of claim 2, wherein the first type is a big data application type.
